(19) United States
(12) Patent Application Publication
(10) Pub. No.: US 2005/0013903 A1
(43) Pub. Date: Jan. 20, 2005

(54) Compositions and methods of addition for calcium supplementation in transparent beverages using tricalcium phosphate

(76) Inventor: Nadeen B. Myers, Wildwood, MO (US)

Correspondence Address: THOMPSON COBURN, LLP, ONE US BANK PLAZA, SUITE 3500, ST LOUIS, MO, 63101, US

(21) Appl. No.: 10/619,971

(22) Filed: Jul. 15, 2003

(51) Int. Cl. A23K 1/175

(52) U.S. Cl. 426/74

(57) ABSTRACT

Methods for supplementing calcium in a transparent, ingestive liquid, such as a clear beverage, using TCP are provided. Also provided are calcium-supplemented fluid composition comprising TCP dissolved in an acidulent solution and a transparent, ingestive liquid. The calcium-supplemented fluid composition meets a variety of the percent RDA for calcium.

Calcium is an essential nutrient for healthy bone development. Calcium and trace mineral supplementation in food is important for adults and children. With normal aging, a human adult, especially women, experience gradual bone loss. Postmenopausal women require more calcium due to the change in their hormonal status, which can accelerate the bone loss rate leading to osteoporosis. Osteoporosis is a metabolic bone disease in which the individual suffers gradual bone loss due to atrophy of the skeletal tissue.

Increased consumption of calcium is expected to mitigate or delay the effects of osteoporosis. Increased dietary intake of calcium has been shown to be effective in minimizing bone loss in the elderly.

Calcium requirements vary throughout an individual's lifetime. Table 1 presents the standard calcium requirements which were established at a National Institute of Health (NIH) conference on optimal calcium intake held Jun. 6-8, 1994. “Optimal Calcium Intake”, JOURNAL OF THE AMERICAN MEDICAL ASSOCIATION, 272(24): 1942-1948, at 1943 (1994). See also U.S. Pat. No. 5,698,222.

TABLE 1
CALCIUM INTAKES/DAILY INTAKE

| GROUP | (in mg of calcium) |
|---|---|
| Infants | |
| Birth-6 months | 400 |
| 6 months-1 year | 600 |
| Children | |
| 1-5 years | 800 |
| 6-10 years | 800-1,200 |
| Adolescents/Young Adults | |
| 11-24 years | 1,200-1,500 |
| Men | |
| 25-65 years | 1,000 |
| Over 65 years | 1,500 |
| Women | |
| 25-50 years | 1,000 |
| Over 50 years (postmenopausal) | |
| On estrogens | 1,000 |
| Not on estrogens | 1,500 |
| Over 65 | 1,500 |
| Pregnant & nursing | 1,200-1,500 |

Given the benefits of calcium, food manufacturers seek new, efficient ways to supplement food products with calcium. Unfortunately, calcium enrichment or fortification can adversely effect the organoleptic properties of the food product to which it is added. Tricalcium phosphate, although widely used, often contributes a “gritty” texture which has limited the level to which it could be included in food product. See, e.g., U.S. Pat. No. 5,449,523, which is incorporated by reference in its entirety.

Manufacturers have chosen beverages as one of the major food products to supplement with calcium. However, because of problems with turbidity, cloudiness, and precipitation, supplementation of calcium has been limited to opaque beverages, such as orange juices or milk. Consumers are less likely to reject these beverages because they cannot readily see the calcium precipitates.

Tricalcium phosphate (“TCP”) is known as a source of high percentage of calcium (at 37.9%). However, TCP has solubility problems. See e.g. U.S. Pat. No. 4,891,198, incorporated by reference in its entirety. The limiting factor in utilizing TCP for a wide-range of beverage products is that TCP is highly insoluble at a pH greater than 3.5% (see FIG. 1). This fact has limited the role of TCP as a calcium fortifier to those beverages that are opaque, i.e., orange juice, which minimizes the visibility of the sediment or precipitated TCP, as precipitates are unattractive, and in some cases, repulsive to consumers. Typically, these same type of juices also require that they be shook prior to serving. This allows the insoluble particles, such as TCP, to be resuspended in the juice to ensure that the consumer is receiving the percent RDA that is represented on the package label.

TCP has also been used as a flow conditioner in powdered beverages or dried mixes. See e.g. U.S. Pat. Nos. 4,178,389 and 3,908,024 (both incorporated by reference in their entirety) and European Patent No. 0225684B1. U.S. Pat. No. 4,508,740, incorporated by reference herein in its entirety, describes a method for making beverage mix tablets in which TCP is used as a disintegrant. When used as a flow conditioner or disintegrant, the amount of TCP used in the mixes is noticeably low. As a source of nutrient supplementation, however, the amount of TCP would need to be significantly increased to meet the RDA of calcium.

In clear beverages that are labeled as “calcium fortified”, the manufacturer used water-soluble calcium sources. These calcium sources are typically organic calcium salts, such as calcium citrate or calcium gluconate, which contain a lower calcium concentration than TCP (see attached chart). Moreover, calcium citrate and calcium gluconate are much more costly raw ingredients than TCP.

TABLE 2

| Fortified Juice | Calcium (Ca) Source |
|---|---|
| Apple | Calcium Lactate |
| Cranberry | Ca Lactate/Ca Citrate |
| Fruit Punch | Calcium Citrate |
| Grape (Apple Grape) | Calcium Citrate |
| Grapefruit | Ca Gluconate/Ca Lactate |
| Orange Strawberry Banana | Ca Lactate/TCP |

Accordingly, a need still exists for a calcium-supplemented beverage in which the calcium source, such as TCP, will not sediment or precipitate out and create a cloudy or turbid appearance in the beverage while still providing a percentage of RDA of calcium. A need also exists for a method for preparing a calcium-supplemented beverage that is less expensive than the alternatives currently used on the market.

### SUMMARY OF INVENTION

Accordingly, the present invention provides compositions and methods for supplementing transparent, ingestive liquid with tricalcium phosphate in an amount sufficient to meet the percent RDA of calcium.

In one aspect, the invention provides a calcium-supplemented fluid composition comprising tricalcium phosphate (TCP), dissolved in an acidulent solution, and a transparent, ingestive liquid, wherein the calcium-supplemented fluid composition has about 10% to about 50% of the RDA of calcium per serving.

In another aspect, the invention provides a calcium-supplemented fluid composition comprising tricalcium phosphate (TCP), dissolved in a citric acid solution, and a transparent, ingestive liquid, wherein said calcium-supplemented fluid composition has about 10% to about 50% of the RDA of calcium per serving and wherein said composition is shelf-ready.

In a further aspect, the invention provides a calcium-supplemented fluid composition comprising TCP and a transparent, ingestive liquid, wherein the composition is shelf-ready and wherein all or almost all of the TCP stays in solution.

In another aspect, the invention provides a method for preparing a calcium-supplemented fluid composition comprising: a) dissolving tricalcium phosphate (TCP) in an acidulent solution to make a first solution with a pH of about 2 to about 3.5; and b) combining the first solution with a sufficient amount of a transparent, ingestive liquid to make a second solution, wherein the second solution has about 10% to about 50% of the RDA of calcium per serving.

In another aspect, the invention provides a composition produced by the method of the present invention.

In another aspect, the invention provides a method for supplementing a transparent, ingestive liquid with calcium, comprising combining said transparent, ingestive liquid with a fluid composition that comprises TCP dissolved in a citric acid solution, wherein the fluid composition has a pH of about 2 to about 3.5.

In another aspect, the invention provides a dry composition comprising TCP and granular or powdered citric acid, wherein the ratio amount of TCP to citric acid is about 1 to 4 by weight, wherein the TCP has a particle size of greater than zero micron to about 44 microns, and wherein the composition dissolves in a transparent, ingestive liquid without producing visible TCP precipitates or sediments.

### BRIEF DESCRIPTION OF THE DRAWINGS

FIG. 1 shows the solubility of tricalcium phosphate in citric acid at different pH levels. The solubility of tricalcium phosphate decreases with increasing pH or as the solution becomes more basic.

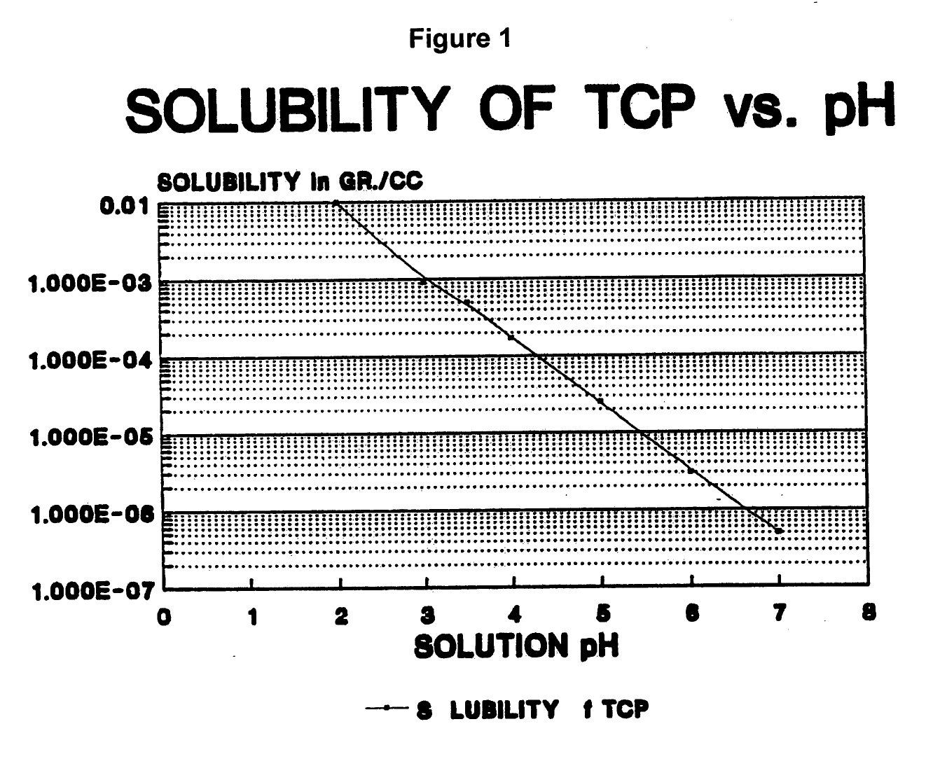

FIG. 2 shows the percent calcium in various calcium salt. For example, a tricalcium phosphate compound contains about 38% calcium.

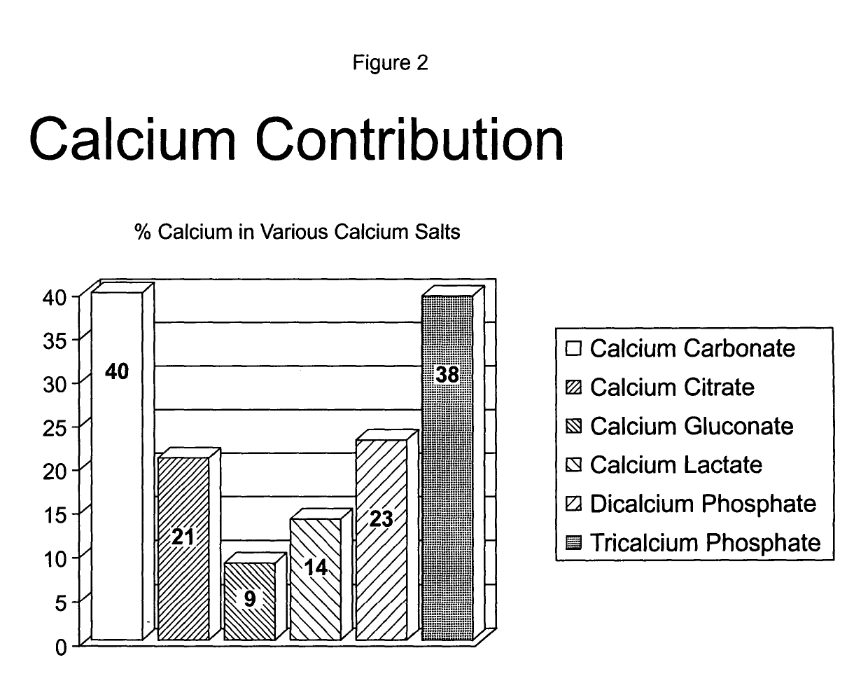

### DETAILED DESCRIPTION OF THE INVENTION

Definitions.

“Juice” refers to a beverage that is completely a natural fruit juice or contains the lowest allowable percentage of juice as defined by the Standard of Identity for a fruit juice.

“Per serving” depends on the particular beverages and may vary from manufacturer to manufacturer of the beverages. Typically, a serving of juice is about 3 to about 6 fluid ounces. More typically, the serving of juice is about 4 fluid ounces. For fortified water, a serving is typically about 7 to about 9 fluid ounces, more typically, 8 fluid ounces.

“Recommended Daily Allowances”, “Recommended Dietary Allowances,” or “RDA” is the amount determined or set by the Food and Nutrition Board of the National Research Council of the USA to be the optimum standards for the main dietary constituents, such as calcium.

“Shelf-ready” refers to the status of a fluid composition, such as a beverage, wherein the TCP is already in solution, and no further action (e.g. diluting, mixing, shaking, heating, etc.) by the consumer, vendor, or supplier is required to keep the TCP in solution and/or to make the fluid composition ready for ingestion, and where the composition provides at least 10% of RDA of calcium per serving.

“Shelf-stable” refers to the condition of a fluid composition, such as a beverage, in which the fluid composition may be left or stored without substantially losing its original properties, such as its appearance, color, taste, and/or nutritional potency.

“Sports drinks” refers to beverages that are consumed to alleviate muscle fatigue during or after vigorous exercise. These beverages are commonly referenced as isotonic beverages, or electrolyte replacement drinks.

“TCP” or tricalcium phosphate exists as at least two different forms: 1) a basic TCP, Ca₁₀ (PO₄)₆(OH)₂ (also known as hydroxyapatite) and 2) a less stable, soluble TCP prepared by Ackilli et al. as described in U.S. Pat. No. 4,891,198. In the present application, TCP refers to hydroxyapatite.

“Transparent, ingestive liquid” refers to a fluid that is translucent, pellucid, substantially free of visible sediment or precipitation, or not turbid or opaque and that can be consumed or taken internally by an animal, preferably a human, as an aliment. For example, orange juice and Gatorade Ice® are considered opaque. On the other hand, apple juice and Propel® fortified water are examples of transparent, ingestive liquids.

The present invention provides compositions and methods for supplementing transparent, ingestive liquid with tricalcium phosphate in an amount sufficient to meet at least 10% of the RDA of calcium.

Precipitation or sedimentation of the calcium supplement can be readily seen by the naked eyes, especially when the liquid is transparent, such as clear beverages. These calcium precipitates are unattractive, and in some cases, repulsive to consumers. TCP offers a less expensive and more efficient calcium alternative than the calcium supplements currently available on the market.

The present invention provides a method for preparing a calcium-supplemented fluid composition comprising: a) dissolving tricalcium phosphate (TCP) in an acidulent solution to make a first solution with a pH of about 2 to about 3.5; and b) combining the first solution with a sufficient amount of a transparent, ingestive liquid to make the calcium-supplemented fluid composition, wherein the calcium-supplemented fluid composition has about 10% to about 50% of the RDA of calcium per serving.

TCP does not readily dissolve in the transparent, ingestive liquid, such as a beverage, when directly added to the liquid. Several particles remain visible and give the beverage a cloudy appearance. Once the mixing is completed, the TCP particles immediately settle out. The present inventor discovered that if the TCP is first dissolved in an acidulent solution, such as citric acid, and then an appropriate amount of the TCP/acidulent solution (hereinafter, “TCP solution”) is added to the beverage, no visible precipitation of TCP in the beverage can be seen by the naked eyes under the visible light.

The amount of the TCP solution to add to the beverage depends on the desired percent of the RDA of calcium per serving of the beverage. Upon solubilizing the TCP in the acidulent solution, the TCP solution is then measured to a particular RDA of calcium, usually given as a percent of calcium, and then added to the beverage of choice. As Table 1 indicates, the RDA of calcium varies with age, gender, and health of the individuals. For most adults, 100% RDA of calcium is about 1000 mg of calcium. Thus, 10% of the RDA of calcium per serving of juice, for example, refers to 100 mg of calcium in about 4 fluid ounces of juice. Preferably, the calcium-supplemented beverage has about 10% to about 50% of the RDA of calcium per serving, more preferably about 10% to about 30%, and still more preferably, about 30%.

Several factors affect the solubility of TCP. For example, TCP dissolves in the acidulent solution at a pH of about 2 to about 3.5, preferably about 2.5 to about 3.0, more preferably about 2.5. Additionally, the size of the TCP particles can affect the solubility of TCP. The larger the TCP particle size, the more difficult it is to dissolve the TCP in the acidulent solution. Preferably, the particle size of the TCP ranges between greater than zero micron to about 44 microns with the average particle size of about 4 to about 8 microns. The particle size also contributes to a good mouth-feel with the absence of chalkiness or grittiness on the tongue.

The pH of certain juices ranges from about 2.56 to about 3.56. Preferably, TCP dissolves in an acidulent solution that has a pH approximately within this range. For example, TCP readily dissolves in citric acid within a pH range of about 2.5 to about 3. Citric acid is found naturally in oranges, lemons, limes, and grapefruits. It may also be chemically synthesized. Other acidulent solution may used, such as malic, fumaric, or phosphoric acid solution.

The invention provides a calcium-supplemented fluid composition comprising tricalcium phosphate (TCP), dissolved in an acidulent solution, preferably citric acid solution, and a transparent, ingestive liquid, wherein the calcium supplemented fluid composition has about 10% to about 50% of the RDA of calcium per serving.

Preferably, the composition is shelf-ready. The calcium-supplemented fluid composition can be ingested without the need for further manipulation of said composition by the consumer, vendor, or distributor, such as, but not limited to, mixing, diluting, shaking, or reconstituting. Most, if not all, of the commercially-available beverages that contain TCP exist in dry or powdered mixes, which the users have to first reconstitute in liquid to produce drinkable beverages. More importantly, because the TCP is not used as a calcium supplement for nutritious reasons, the amount of TCP in these mixes are low and do not meet the RDA of calcium per serving. Additionally, the TCP in these solutions will precipitate out after mixing.

Preferably, the calcium-supplement fluid composition of the present invention has about 10% to about 30% of the RDA of calcium per serving. More preferably, the calcium-supplemented fluid composition has about 30% of the RDA of calcium per serving.

In an embodiment, the transparent, ingestive liquid is a beverage. Preferably, the beverage is shelf-stable. The temperature at which a shelf-stable fluid composition, such as a beverage, may be left or stored is envisioned to include all temperatures at which the fluid composition is stable. One such embodiment includes temperatures between about 0° C. to about room temperature (up to about 25° C.). Another embodiment includes temperatures at which the fluid composition is flowable. Another embodiment includes temperatures above the freezing temperature of the fluid composition. Another embodiment includes temperatures at about room temperature.

Furthermore, the beverage may be a juice or a sports drink The beverage may be carbonated, flavored, and/or colored. The color may derive from a natural or artificial source or both.

In another embodiment, the TCP has a particle size that ranges between greater than zero micron to about 44 microns. Preferably, the average particle size is about 4 microns to about 8 microns.

The acidulent solution used to dissolve the TCP may be selected from the group consisting of citric, malic, fumaric, and phosphoric acid solution. Preferably, once dissolved in the acidulent solution, all or almost all of the TCP stays in solution. That is, no TCP precipitates or particles can be observed by the naked eyes under the visible light even after the calcium-supplemented fluid composition has been stored for a long period of time at room temperature.

The present invention also provides a method for supplementing a transparent, ingestive liquid with calcium, comprising combining said transparent, ingestive liquid with a fluid composition that comprises TCP, dissolved in an acidulent solution, wherein the fluid composition has a pH of about 2 to about 3.5.

The calcium-supplemented fluid composition may be prepared from a dry composition comprising TCP and granular or powdered citric acid, wherein the ratio amount of TCP to citric acid is about 1 to 4 by weight. The TCP has a particle size of greater than zero micron to about 44 microns. Preferably, the TCP has an average particle size of about 4 to about 8 microns. The dry composition dissolves in a transparent, ingestive liquid without producing visible TCP precipitates or sediments.

All references cited herein are hereby incorporated by reference in their entirety.

### EXAMPLES

### Example 1

This example demonstrates a preparation of TCP to meet 10% (100 mg) of the calcium RDA in one-100 ml serving. About 2.7 grams of TCP were dissolved in 100 mL of a citric acid solution, while maintaining a pH of about 2.5 to about 3.0. This resulted in about 10.23 mg of calcium per milliliter of citric acid solution. About 10 ml of this TCP/citric acid solution was added to 90 mL of the beverage of choice, e.g. apple juice. This resulted in about 102.3 mg of calcium per 100 mL of beverage. The resulting calcium-supplemented beverage contains no visible TCP precipitates or particles and did not have a “gritty” mouth-feel taste. The experiment was repeated with a different amount of TCP to create a calcium-supplemented beverage containing up to 50% of the RDA for calcium per serving. The resulting calcium-supplemented beverage contains no visible TCP precipitates or particles and did not have a “gritty” mouth-feel or chalky aftertaste.

The example provided above is for illustrative purposes only, and not to limit the scope of the present invention. In light of the present disclosure, numerous embodiments within the scope of the claims will be apparent to those of ordinary skill in the art.

1. A calcium-supplemented fluid composition comprising tricalcium phosphate (TCP), dissolved in an acidulent solution, and a transparent, ingestive liquid, wherein the calcium-supplemented fluid composition has about 10% to about 50% of the RDA of calcium per serving.

2. The composition of claim 1, wherein the calcium-supplemented fluid composition has about 10% to about 30% of the RDA of calcium per serving.

3. The composition of claim 2, the calcium-supplemented fluid composition has about 30% of the RDA of calcium per serving.

4. The composition of claim 1, wherein the transparent, ingestive liquid is a beverage.

5. The composition of claim 4, wherein the beverage is shelf-stable.

6. The composition of claim 5, wherein the beverage is stored at a temperature between about 0° C. to about room temperature (up to about 25° C.).

7. The composition of claim 6, wherein the temperature is above a freezing temperature of the beverage.

8. The composition of claim 7, wherein the temperature is at about room temperature.

9. The composition of claim 5, wherein the beverage is stored at a temperature in which the beverage is flowable.

10. The composition of claim 4, wherein the beverage is carbonated.

11. The composition of claim 4, wherein the beverage is flavored.

12. The composition of claim 4, wherein the beverage is colored.

13. The composition of claim 4, wherein the beverage is a juice or a sports drink.

14. The composition of claim 1, wherein the TCP has a particle size of greater than zero micron to about 44 microns.

15. The composition of claim 1, wherein the TCP has an average particle size of about 4 microns to about 8 microns.

16. The composition of claim 1, wherein the acidulent solution is selected from the group consisting of citric, malic, fumaric, and phosphoric acid solution.

17. A calcium-supplemented fluid composition comprising tricalcium phosphate (TCP), dissolved in a citric acid solution, and a transparent, ingestive liquid, wherein the calcium-supplemented fluid composition has about 10% to about 50% of the RDA of calcium per serving, and wherein the calcium-supplemented fluid composition is shelf-ready.

18. A calcium-supplemented fluid composition comprising TCP and a transparent, ingestive liquid, wherein the calcium-supplemented fluid composition is shelf-ready and wherein all or almost all of the TCP stays in solution.

19. A method for preparing a calcium-supplemented fluid composition comprising:
a) dissolving tricalcium phosphate (TCP) in an acidulent solution to make a first solution with a pH of about 2 to about 3.5; and
b) combining the first solution with a sufficient amount of a transparent, ingestive liquid to make a calcium-supplemented fluid composition, wherein the calcium-supplemented fluid composition has about 10% to about 50% of the RDA of calcium per serving.

20. The method of claim 19, wherein the calcium-supplemented fluid composition has 10% to about 30% of the RDA of calcium per serving.

21. The method of claim 20, wherein the calcium-supplemented fluid composition has about 30% of the RDA of calcium per serving.

22. The method of claim 19, wherein the transparent, ingestive liquid is a beverage.

23. The method of claim 22, wherein the beverage is shelf-stable.

24. The method of claim 23, wherein the beverage is stored at a temperature between about 0° C. to about room temperature (up to about 25° C.).

25. The method of claim 24, wherein the temperature is above a freezing temperature of the beverage.

26. The method of claim 25, wherein the temperature is at about room temperature.

27. The method of claim 23, wherein the beverage is stored at a temperature in which the beverage is flowable.

28. The method of claim 22, wherein the beverage is carbonated.

29. The method of claim 22, wherein the beverage is flavored.

30. The method of claim 22, wherein the beverage is colored.

31. The method of claim 22, wherein the beverage is a juice or sports drink.

32. The method of claim 19, wherein the TCP has a particle size of greater than zero micron to about 44 microns.

33. The method of claim 32, wherein the TCP has an average particle size of about 4 microns to about 8 microns.

34. The method of claim 19, wherein the acidulent solution is selected from the group consisting of citric, malic, fumaric, and phosphoric acid solution.

35. A composition produced by the method of claim 19.

36. A method for supplementing a transparent, ingestive liquid with calcium, comprising combining said transparent, ingestive liquid with a fluid composition that comprises TCP, dissolved in a citric acid solution, wherein the fluid composition has a pH of about 2 to about 3.5.

37. A dry composition comprising TCP and granular or powdered citric acid, wherein the ratio amount of TCP to citric acid is about 1 to 4 by weight, wherein the TCP has a particle size of greater than zero micron to about 44 microns, and wherein the dry composition dissolves in a transparent, ingestive liquid without producing visible TCP precipitates or sediments.

38. The dry composition of claim 37, wherein the TCP has an average particle size of about 4 to about 8 microns.

39. A method for supplementing a transparent, ingestive liquid with calcium, comprising combining said transparent, ingestive liquid with the dry composition of claim 37.
